(19) United States
(12) Patent Application Publication
(10) Pub. No.: US 2017/0089789 A1
(43) Pub. Date: Mar. 30, 2017

(54) PRESSURE SENSOR, ALTIMETER, ELECTRONIC APPARATUS, AND MOVING OBJECT

(71) Applicant: Seiko Epson Corporation, Tokyo (JP)

(72) Inventor: Yoko KANEMOTO, Fujimi (JP)

(21) Appl. No.: 15/262,308

(22) Filed: Sep. 12, 2016

(30) Foreign Application Priority Data
Sep. 28, 2015 (JP) 2015-189318

(51) Int. Cl. G01L 9/00; G01C 5/06

(52) U.S. Cl. CPC G01L 9/0054; G01C 5/06

(57) ABSTRACT

A pressure sensor includes a package having a cavity, a pressure sensor device arranged in the cavity, and a filler that covers the pressure sensor device. The pressure sensor device has a diaphragm having a pressure receiving surface and a hollow section, and in the direction of a normal to the pressure receiving surface, between a first imaginary plane containing the lower surface of the pressure sensor device and a second imaginary plane containing the upper surface of the pressure sensor device is located a middle point of the filler in the normal direction.

### BACKGROUND

1. Technical Field

The present invention relates to a pressure sensor, an altimeter, an electronic apparatus, and a moving object.

2. Related Art

As a pressure sensor of related art, the configuration described in JP-A-2008-8762 is known. The pressure sensor described in JP-A-2008-8762 includes a package (case), a pressure sensor device (sensor chip) arranged in the package, and a filler that is arranged in the package and covers the pressure sensor device. In the pressure sensor, when pressure is applied onto a diaphragm of the pressure sensor device via the filler, the diaphragm bends in accordance with the magnitude of the received pressure, and the received pressure is sensed on the basis of the amount of bend.

In the pressure sensor described in JP-A-2008-8762, however, since the pressure sensor device is shifted toward one side in the filler, the weight (self-weight) of the filler applied onto the diaphragm, for example, when the pressure sensor is oriented upward, as shown in FIG. 2 of JP-A-2008-8762, undesirably differs from the weight applied onto the diaphragm, for example, when the pressure sensor is oriented in the opposite direction or downward. Therefore, even when the pressure sensor receives the same magnitude of pressure, the amount of bend of the diaphragm changes in accordance with the orientation of the pressure sensor, undesirably resulting in a change in the magnitude of sensed pressure accordingly. As described above, in the pressure sensor described in JP-A-2008-8762, a sensed pressure value shifts in accordance with the orientation of the pressure sensor, and the pressure sensor cannot therefore undesirably provide excellent sensing accuracy.

### SUMMARY

An advantage of some aspects of the invention is to provide a pressure sensor capable of reducing a shift of a sensing result due to the orientation of a pressure sensor device and further provide a reliable altimeter, electronic apparatus, and a moving object including the pressure sensor.

The advantage can be achieved by the following aspects of the invention.

A pressure sensor according to an aspect of the invention includes a package having a cavity, a pressure sensor device arranged in the cavity, and a filler that is arranged in the cavity and covers the pressure sensor device, the pressure sensor device has a diaphragm having a pressure receiving surface and a pressure reference chamber arranged on a side opposite the pressure receiving surface with respect to the diaphragm, and in a direction of a normal to the pressure receiving surface, between a first imaginary plane containing an end surface that is a surface of the pressure sensor device and faces the pressure receiving surface and a second imaginary plane containing an end surface that is another surface of the pressure sensor device and faces the pressure reference chamber is located a middle point between opposite ends of the filler in the normal direction.

A pressure sensor capable of reducing a shift of a sensing result due to the orientation of a pressure sensor device (orientation in the direction of a normal to the diaphragm that coincides with the vertical direction, in particular) can therefore be provided.

In the pressure sensor according to the aspect of the invention, it is preferable that the middle point between the opposite ends of the filler in the normal direction is located between a third imaginary plane containing the pressure receiving surface and the second imaginary plane.

With this configuration, the shift of a sensing result can be further reduced.

In the pressure sensor according to the aspect of the invention, it is preferable that the middle point between the opposite ends of the filler in the normal direction is located between the third imaginary plane and a fourth imaginary plane containing a surface of the diaphragm on a side opposite the pressure receiving surface.

With this configuration, the shift of a sensing result can be still further reduced.

In the pressure sensor according to the aspect of the invention, it is preferable that, in a plan view viewed in the normal direction, a middle point of the filler in an in-plane direction of the pressure receiving surface is located in an area that overlaps with the pressure sensor.

With this configuration, a shift of a sensing result due to the orientation of a pressure sensor device (orientation in the in-plane direction of the diaphragm that coincides with the vertical direction, in particular) can be reduced.

In the pressure sensor according to the aspect of the invention, it is preferable that, in the plan view viewed in the normal direction, the middle point of the filler in the in-plane direction is located in an area that overlaps with the pressure receiving surface.

With this configuration, the shift of a sensing result can be further reduced.

It is preferable that the pressure sensor according to the aspect of the invention further includes a circuit substrate arranged in the cavity.

This configuration allows the distance of wiring lines that connect the circuit substrate (IC chip) to the pressure sensor device to be shorter than in a case where the circuit substrate is arranged in a position outside the package. Noise contamination is therefore unlikely to occur.

In the pressure sensor according to the aspect of the invention, it is preferable that, in the direction of a normal to the pressure receiving surface, the pressure sensor device and the circuit substrate are so arranged as to be aligned with each other.

With this configuration, the size of the pressure sensor can be reduced.

In the pressure sensor according to the aspect of the invention, it is preferable that, in the in-plane direction of the pressure receiving surface, the pressure sensor device and the circuit substrate are so arranged as to be aligned with each other.

With this configuration, the size of the pressure sensor can be reduced.

In the pressure sensor according to the aspect of the invention, it is preferable that the package has a protrusion that protrudes inward in the cavity.

With this configuration, the volume of the cavity can be reduced, whereby the amount of filler with which the cavity is filled can be reduced.

An altimeter according to another aspect of the invention includes the pressure sensor according to the aspect of the invention.

With this configuration, a reliable altimeter can be provided.

An electronic apparatus according to another aspect of the invention includes the pressure sensor according to the aspect of the invention.

With this configuration, a reliable electronic apparatus can be provided.

A moving object according to another aspect of the invention includes the pressure sensor according to the aspect of the invention.

With this configuration, a reliable moving object can be provided.

### BRIEF DESCRIPTION OF THE DRAWINGS

The invention will be described with reference to the accompanying drawings, wherein like numbers reference like elements.

FIG. 1 is a cross-sectional view of a pressure sensor according to a first embodiment of the invention.

FIG. 2 is a plan view of the pressure sensor shown in FIG. 1.

FIG. 3 is a cross-sectional view of a pressure sensor device provided in the pressure sensor shown in FIG. 1.

FIG. 4 is a plan view of a pressure sensor section provided in the pressure sensor device shown in FIG. 3.

FIG. 5 shows a bridge circuit including the pressure sensor section shown in FIG. 4.

FIG. 6 shows the arrangement of the pressure sensor device and a filler.

FIG. 7 is a cross-sectional view showing a pressure sensor according to a second embodiment of the invention.

FIG. 8 is a plan view of the pressure sensor shown in FIG. 7.

FIG. 9 is a perspective view showing an example of an altimeter according to an embodiment of the invention.

FIG. 10 is a front view showing an example of an electronic apparatus according to an embodiment of the invention.

FIG. 11 is a perspective view showing an example of a moving object according to an embodiment of the invention.

### DESCRIPTION OF EXEMPLARY EMBODIMENTS

A pressure sensor, an altimeter, an electronic apparatus, and a moving object according to embodiments of the invention will be described below in detail with reference to the accompanying drawings.

### First Embodiment

A pressure sensor according to a first embodiment of the invention will first be described.

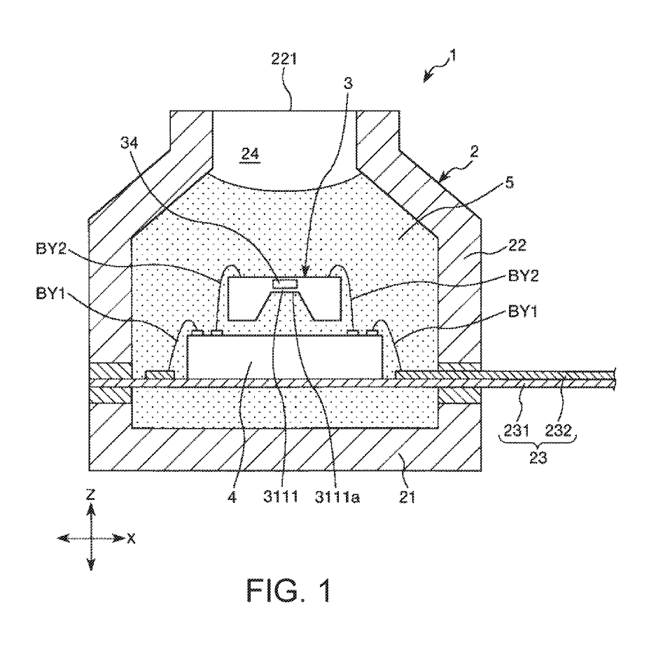

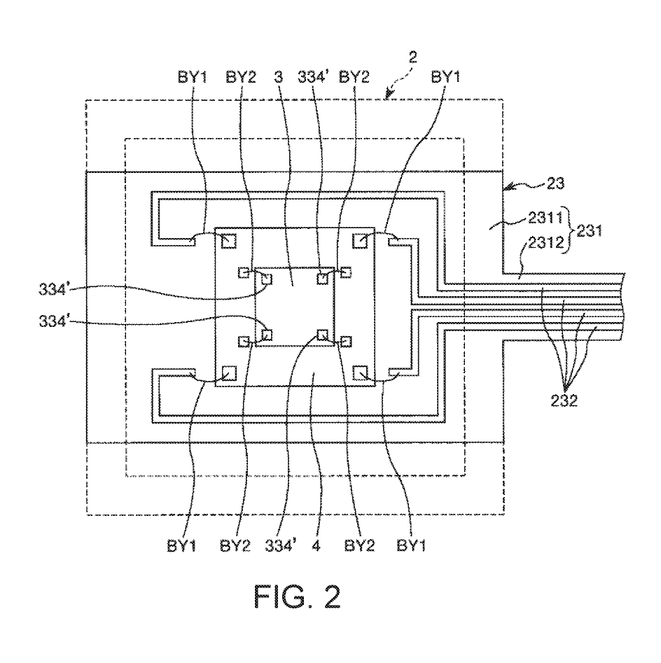

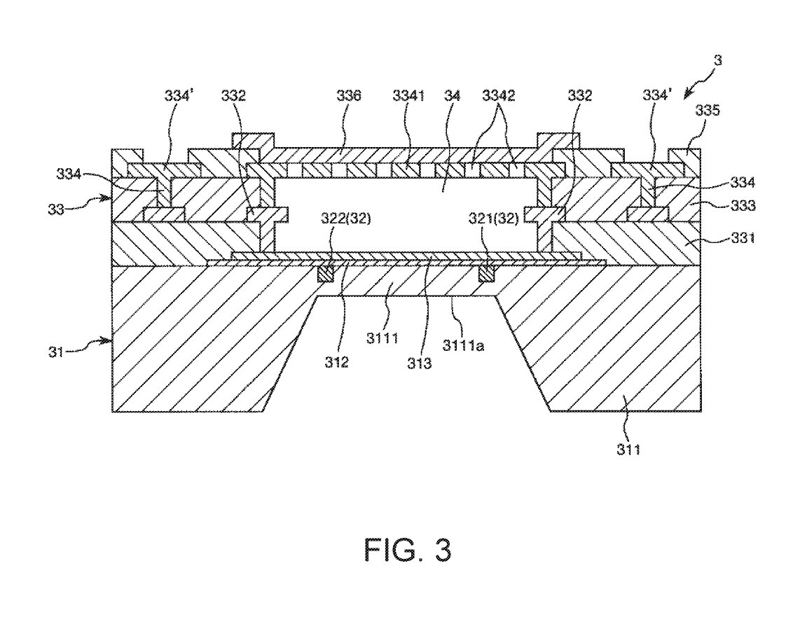

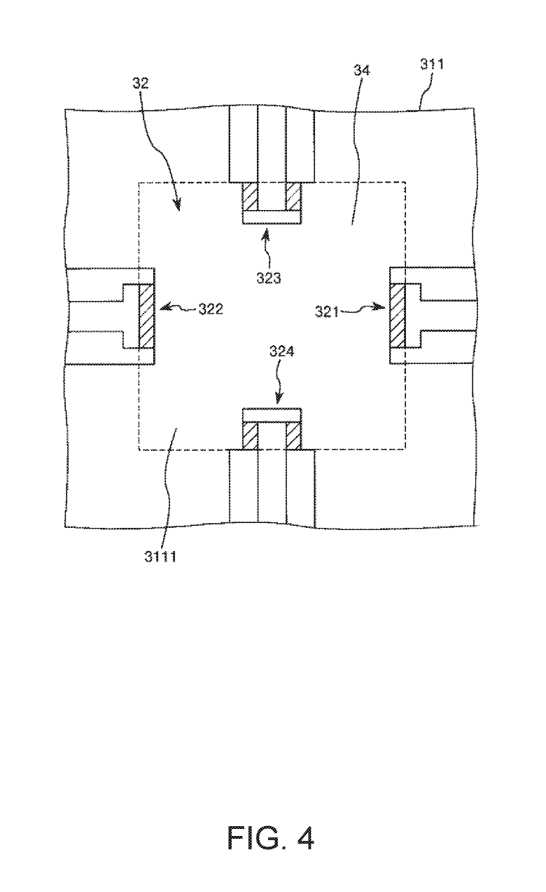

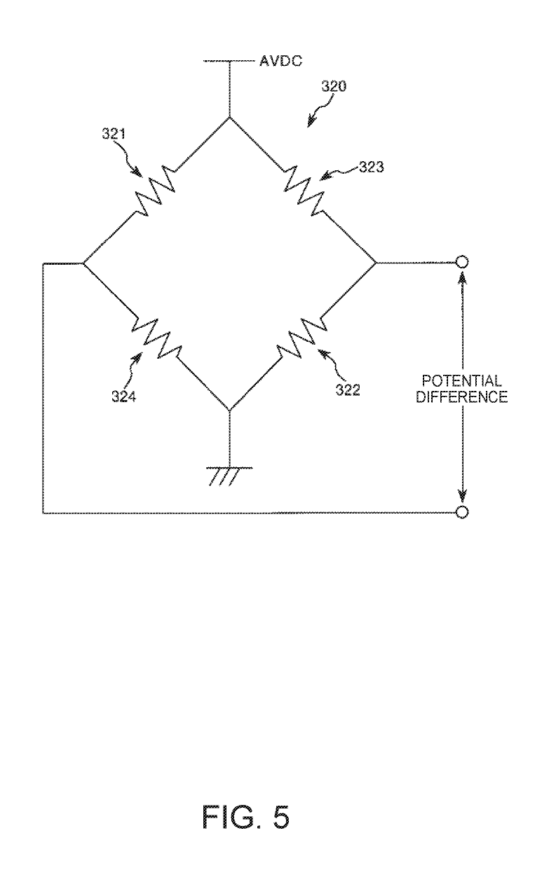

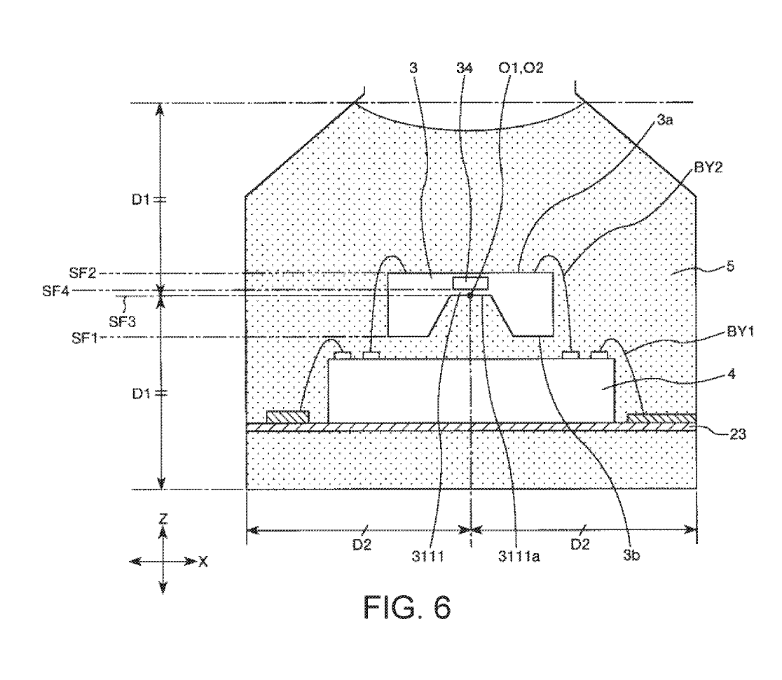

FIG. 1 is a cross-sectional view of the pressure sensor according to the first embodiment of the invention. FIG. 2 is a plan view of the pressure sensor shown in FIG. 1. FIG. 3 is a cross-sectional view of a pressure sensor device provided in the pressure sensor shown in FIG. 1. FIG. 4 is a plan view of a pressure sensor section provided in the pressure sensor device shown in FIG. 3. FIG. 5 shows abridge circuit including the pressure sensor section shown in FIG. 4. FIG. 6 shows the arrangement of the pressure sensor device and a filler. In the following description, the upper side in FIG. 1 is also called “upper,” and the lower side in FIG. 1 is also called “lower.”

A pressure sensor 1 shown in FIG. 1 includes a package 2, a pressure sensor device 3 and an IC chip (circuit substrate) 4, which are accommodated in the package 2, and a filler 5, which is accommodated in the package 2 and covers (surrounds) the pressure sensor device 3 and the IC chip 4. The components listed above will be sequentially described below.

### Package

The package 2 accommodates the pressure sensor device 3 in a cavity 24 formed in the package 2. The package 2 has a base 21, a hosing 22, and a flexible wiring substrate 23, which are bonded to each other with the base 21 and the housing 22 sandwiching the flexible wiring substrate 23. An opening 221, which leads to the cavity 24, is formed through the upper surface of the housing 22, and the opening 221 allows pressure to be conveyed to the pressure sensor device 3.

The flexible wiring substrate 23 has a function of supporting the IC chip 4 in the package 2 and extracting wiring lines connected to the IC chip 4 out of the package 2. The thus configured flexible wiring board 23 has a base board 231 having flexibility and wiring lines 232 formed in the base board 231.

The base board 231 has a base section 2311, which is arranged in the cavity 24, and a belt-shaped belt body 2312, which protrudes from the base section 2311 and is drawn out of the package 2, as shown in FIG. 2. The IC chip 4 is fixed to the base section 2311, for example, via an adhesive that is not shown. The material of which the base section 2311 is made is not limited to a specific material and may be any flexible material, for example, polyimide, polyethylene terephthalate (PET), polyethylene naphthalate (PEN), and polyethersulfone (PES), and one of the materials described above or a combination of two or more of the materials described above may be used.

The wiring lines 232 are so arranged as to connect position inside the package 2 to portions outside the package 2. The wiring lines 232 are connected to the IC chip 4 via bonding wires BY1, whereby the wiring lines 232 are electrically connected to the IC chip 4. In the present embodiment, four wiring lines 232 are provided, but the number of wiring lines 232 is not limited to four and may be changed as appropriate in accordance with the number of terminals of the IC chip 4.

### Pressure Sensor Device

The pressure sensor device 3 is a sensor device capable of sensing received pressure. The pressure sensor device 3 includes, a substrate 31, a pressure sensor section 32, a device surrounding structure 33, a hollow section 34, and a semiconductor circuit (circuit) that is not shown, as shown in FIG. 3.

The substrate 31 is formed by stacking a first insulating film 312, which is formed of a silicon oxide film, and a second insulating film 313, which is formed of a silicon nitride film, in this order on a semiconductor substrate 311, which is made of silicon. It is noted that the semiconductor substrate 311 is not limited to a silicon substrate and can, for example, be an SOI substrate.

The semiconductor substrate 311 is provided with a diaphragm 3111, which is thinner than the portion around the diaphragm 3111 and undergoes bending deformation under pressure. The diaphragm 3111 is formed by providing a bottomed recess that is open through the lower surface of the semiconductor substrate 311, and the lower surface of the diaphragm 3111 (surface in contact with filler 5) serves as a pressure receiving surface 3111a.

The semiconductor circuit that is not shown is formed in the thus configured semiconductor substrate 311. The semiconductor circuit includes a MOS transistor or any other active device, a capacitor, an inductor, a resister, a diode, wiring lines, and other circuit elements formed as required.

The pressure sensor section 32 has four piezo-resistance sections 321, 322, 323, and 324, which are provided in the diaphragm 3111, as shown in FIG. 4. The piezo-resistance sections 321, 322, 323, and 324 are electrically connected to each other via wiring lines to form a bridge circuit (Wheatstone bridge circuit) 320 shown in FIG. 5, which is connected to the semiconductor circuit described above. The bridge circuit 320 outputs a signal (voltage) according to the resistance values of the piezo-resistance sections 321, 322, 323, and 324 that change in accordance with stress induced by the bending deformation of the diaphragm 3111.

The piezo-resistance sections 321, 322, 323, and 324 and the wiring lines are formed, for example, by doping (diffusing or implanting) an impurity, such as phosphorus and boron, into the semiconductor substrate 311.

The device surrounding structure 33 defines the hollow section 34 between the device surrounding structure 33 and the substrate 31. The device surrounding structure 33 has an interlayer insulating film 331, a wiring layer 332, which is formed on the interlayer insulating film 331, an interlayer insulating film 333, which is formed on the wiring layer 332, a wiring layer 334, which is formed on the interlayer insulating film 333, a surface protective film 335, which is formed on the wiring layer 334, and a sealing layer 336, as shown in FIG. 3.

The wiring layer 334 has a coating layer 3341, which has a plurality of narrow holes 3342, which allow communication between the space inside the hollow section 34 and the space outside the hollow section 34, and the sealing layer 336 arranged on the coating layer 3341 seals the narrow holes 3342. The narrow holes 3342 are holes that allow an etching liquid to enter and go out of the hollow section 34 when release etching is performed in the hollow section 34 (when sacrifice layer that fills hollow section 34 is removed), and the narrow holes 3342 are sealed by the sealing layer 336 after the release etching is completed.

The wiring layers 332 and 334 are so formed as to surround the hollow section 34 and each include a wiring layer that functions as an etching stop layer when the release etching is performed in the hollow section 34 and a wiring layer that forms the wiring lines of the semiconductor circuit. The semiconductor circuit is drawn by the wiring layers 332 and 334 onto the upper surface of the pressure sensor device 3, and part of the wiring layer 334 forms connection terminals 334′, which are exposed through the surface protective film 335.

Each of the interlayer insulating films 331 and 333 is not limited to a specific insulating film and can, for example, be a silicon oxide film. Each of the wiring layers 332 and 334 is not limited to a specific layer and can, for example, be a metal film, such as an aluminum film. The sealing layer 336 is not limited to a specific layer and can be a metal film made, for example, of Al, Cu, W, Ti, or TiN. The surface protective film 335 is not limited to a specific film and can be a silicon oxide film, a silicon nitride film, a polyimide film, an epoxy resin film, or any other resistant film that protects the device, for example, against water, dust, and scratches.

The hollow section 34 is a sealed space and functions as a pressure reference chamber that provides a reference value of the pressure detected with the pressure sensor device 3. The hollow section 34 is located on the side opposite the pressure receiving surface 3111a of the diaphragm 3111 and so arranged as to overlap with the diaphragm 3111. The hollow section 34 is preferably a vacuum (having pressure approximately lower than or equal to 10 Pa, for example). Providing the vacuum hollow section 34 allows the pressure sensor device 3 to be used as what is called an “absolute pressure sensor” that detects pressure with respect to the vacuum. It is, however, noted that the hollow section 34 does not need to be the vacuum and may, for example, be a space having pressure equal to the atmospheric pressure, a reduced pressure space having pressure lower than the atmospheric pressure, or an increased pressure space having pressure higher than the atmospheric pressure.

The pressure sensor device 3 has been described above. The thus configured pressure sensor device 3 is connected to the IC chip 4 via bonding wires BY2 and so supported as to hang from the IC chip 4 (to be separate from IC chip 4). The bonding wires BY2 connect the connection terminals 334′ to the terminals of the IC chip 4 so as to electrically connect the pressure sensor device 3 to the IC chip 4.

In the present embodiment, the pressure sensor device 3 is connected to the IC 4 via the bonding wires BY2, but not necessarily. The pressure sensor device 3 may instead be connected to the flexible wiring substrate 23 via the bonding wires BY2. In this case, the pressure sensor device 3 may be electrically connected to the IC chip 4 via the bonding wires BY1, BY2 and the wiring lines 232.

### IC Chip

The IC chip 4 is provided with a semiconductor circuit. The semiconductor circuit in the IC chip 4 and the semiconductor circuit described above in the pressure sensor device 3 include, for example, a drive circuit for supplying the bridge circuit 320 with voltage, a temperature compensation circuit that performs temperature compensation on the output from the bridge circuit 320 in accordance with the temperature of the pressure sensor, and an output circuit that converts the output from the temperature compensation circuit into an output in a predetermined output form (such as CMOS, LV-PECL, and LVDS) and outputs the converted output. The arrangement of the drive circuit, the temperature compensation circuit, the output circuit, and other circuits is not limited to a specific arrangement. For example, the drive circuit may be formed in the semiconductor circuit in the pressure sensor device 3, and the temperature compensation circuit and the output circuit may be formed in the semiconductor circuit in the IC chip 4.

The configuration in which the IC chip 4 is so provided as to be separate from the pressure sensor device 3 allows reduction in size of the pressure sensor device 3 as compared, for example, with a case where the IC chip 4 is omitted and the circuits described above are all formed in the pressure sensor device 3. Further, since the length of the wiring lines that connect the IC chip 4 to the pressure sensor device 3 can be shorter, for example, than in a case where the IC chip 4 is arranged in a position outside the package 2, a signal propagating through each of the wiring lines is unlikely to be contaminated with noise.

Further, the IC chip 4 is so arranged as to be aligned with (overlap with) the pressure sensor device 3 in the upward/downward direction (direction Z of normal to pressure receiving surface 3111a). The amount of increase in the dimension of the pressure sensor 1 in the lateral direction (in-plane direction X of pressure receiving surface 3111a) can therefore be suppressed, whereby the size of the pressure sensor 1 can be reduced.

### Filler

The filler 5 is made of liquid or gel, fills (is arranged in) the cavity 24, and covers the pressure sensor device 3 and the IC chip 4 accommodated in the cavity 24, as shown in FIG. 1. The pressure applied to the pressure sensor 1 therefore acts on the pressure receiving surface 3111a of the pressure sensor device 3 through the opening 221 of the package 2 and via the filler 5.

The thus arranged filler 5 can protect the pressure sensor device 3 and the IC chip 4 (primarily against dust and water) and reduce external stress acting on the pressure sensor 1. Further, the filler 5 causes the pressure sensor device 3 and the IC chip 4 to float in the cavity 24 (prevents pressure sensor device 3 and IC chip 4 from being in contact with inner wall of cavity 24). Vibration and other types of turbulence are therefore unlikely to be conveyed to the pressure sensor device 3 or the IC chip 4 via the package 2, whereby a decrease in pressure detection accuracy can be reduced.

The thus functioning filler 5 only needs to be a material so characterized as to be softer than the pressure sensor device 3, the IC chip 4, and the package 2 and can, for example, be silicone oil, fluorine-based oil, or silicone gel.

The components that form the pressure sensor 1 have been described above. The arrangement of the pressure sensor device 3 and the filler 5, which is one of the features of the pressure sensor 1, will subsequently be described in detail.

In the direction Z of a normal to the pressure receiving surface 3111a, let 3a be the upper surface of the pressure sensor device 3 (end surface facing hollow section 34), and let 3b be the lower surface of the pressure sensor device 3 (end surface facing pressure receiving surface 3111a), as shown in FIG. 6. The upper surface 3a and the lower surface 3b of the pressure sensor device 3 are parallel to the pressure receiving surface 3111a. Further, let a first imaginary plane SF1 be a plane containing the lower surface 3b of the pressure sensor device 3, and let a second imaginary plane SF2 be a plane containing the upper surface 3a of the pressure sensor device 3. Under these definitions, the middle point O1 between the opposite ends of the filler 5 in the normal direction Z is located between the first imaginary plane SF1 and the second imaginary plane SF2. Variation in sensed pressure due to the posture of the pressure sensor 1 can therefore be reduced, whereby the pressure sensor 1 has an excellent pressure sensing characteristic.

The lower surface 3b and the upper surface 3a are parallel to the pressure receiving surface 3111a in the present embodiment, but not necessarily. Also in this case, the middle point O1 can be located between the first imaginary plane SF1 and the second imaginary plane SF2, whereby the pressure sensor 1 has an excellent pressure sensing characteristic.

That is, the arrangement described above allows reduction in the difference in the weight of the filler 5 (water pressure) applied onto the pressure receiving surface 3111a between a first posture in which the opening 221 of the package 2 faces upward in the vertical direction (posture in which pressure receiving surface 3111a faces downward in vertical direction) and a second posture in which the opening 221 of the package 2 faces downward in the vertical direction (posture in which pressure receiving surface 3111a faces upward in vertical direction). Unwanted external force other than the pressure received by the pressure receiving surface 3111a in the first posture is roughly equal to the unwanted external force in the second posture, whereby the difference in sensed pressure (value of output from pressure sensor section 32) between the first posture and the second posture can be reduced.

Further, let a third imaginary plane SF3 be a plane containing the pressure receiving surface 3111a, and let a fourth imaginary plane SF4 be a plane containing the upper surface of the diaphragm 3111 (surface opposite pressure receiving surface 3111a). Under these definitions, the middle point O1 between the opposite ends of the filler 5 in the normal direction Z is preferably located between the second imaginary plane SF2 and the third imaginary plane SF3, more preferably between the third imaginary plane SF3 and the fourth imaginary plane SF4, still more preferably on the third imaginary plane SF3 as in the present embodiment. When the middle point O1 of the filler 5 in the normal direction Z is located in any of the positions described above, the advantageous effect described above is more markedly provided.

Further, the middle point O2 of the filler 5 in the in-plane direction X of the pressure receiving surface 3111a is located in an area that overlaps with the pressure sensor device 3 in a plan view viewed in the normal direction Z, as shown in FIG. 6. When the middle point O2 of the filler 5 is thus positioned, the difference in pressure sensing due to the posture of the pressure sensor 1 can be further reduced.

That is, in a third posture in which the opening 221 of the package 2 is oriented in the horizontal direction (posture in which pressure receiving surface 3111a extends along vertical direction), the arrangement described above allows reduction in the difference in the weight of the filler 5 (water pressure) applied onto the pressure receiving surface 3111a among postures (orientations) contained in the third posture. Unwanted external force other than the pressure received by the pressure receiving surface 3111a is therefore roughly constant among the postures contained in the third posture, whereby variation in sensed pressure in the third posture can be reduced.

Moreover, the middle point O2 of the filler 5 is preferably located in an area that overlaps with the pressure receiving surface 3111a in the plan view viewed in the normal direction Z, more preferably, the middle point O2 coincides with the center of the pressure receiving surface 3111a as in the present embodiment. When the middle point O2 of the filler 5 is thus positioned, the advantageous effect described above is more markedly provided.

Further, in the present embodiment, to reduce the difference in sensed pressure between the first or second posture and the third posture, the depth of the middle point O1 (distance from end of filler 5 in normal direction Z to middle point O1) D1 is roughly equal to the depth of the middle point O2 (distance from end of filler 5 in in-plane direction X to middle point O2) D2. Specifically, the depths D1 and D2 preferably satisfy the relationship 0.8D1≦D2≦1.2D1, more preferably satisfy the relationship 0.9D1≦D2≦1.1D1, still more preferably satisfy the relationship 0.95D1≦D2≦1.05D1. The difference in sensed pressure between the first or second posture and the third posture can thus be reduced, whereby the pressure sensor 1 has an excellent pressure sensing characteristic.

### Second Embodiment

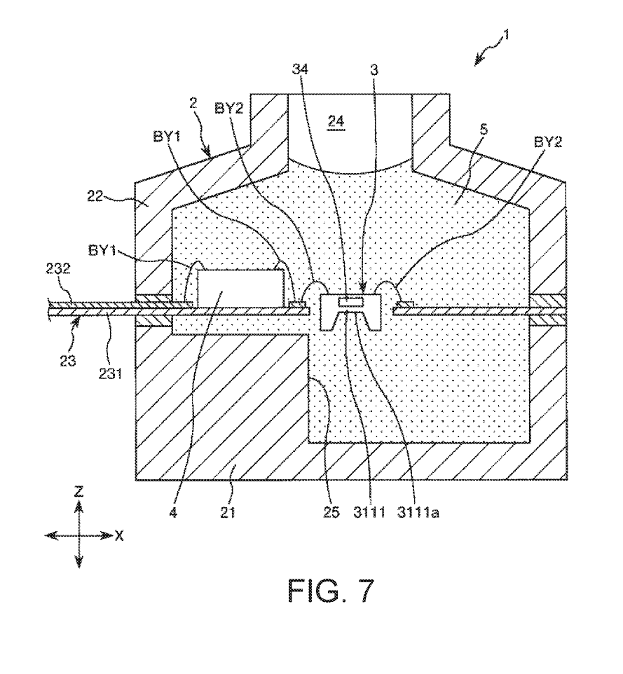

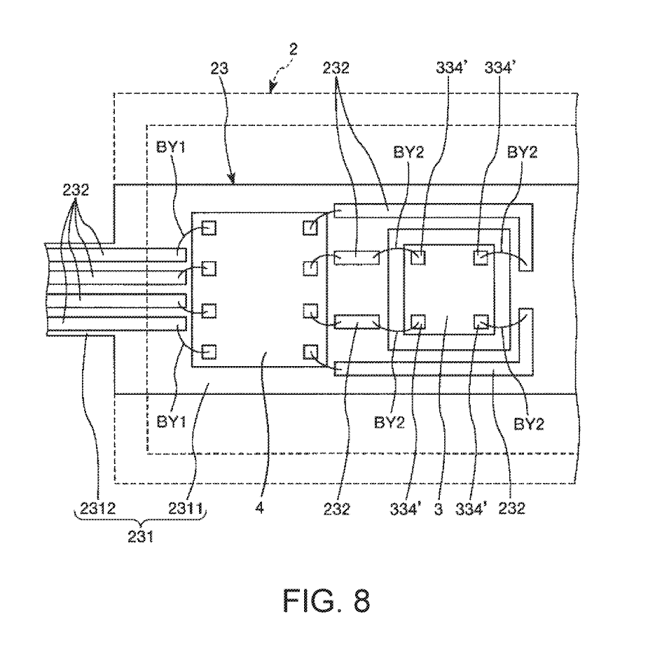

FIG. 7 is a cross-sectional view showing a pressure sensor according to a second embodiment of the invention. FIG. 8 is a plan view of the pressure sensor shown in FIG. 7.

The second embodiment of the invention will be described below. The description will be primarily made on differences from the embodiment described above, and the same items will not be described.

The second embodiment is the same as the first embodiment described above except that the pressure sensor device and the IC chip are arranged differently.

In the pressure sensor 1 according to the present embodiment, the pressure sensor device 3 and the IC chip 4 are so arranged as to be aligned with each other in the in-plane direction X of the pressure receiving surface 3111a, as shown in FIGS. 7 and 8. The arrangement allows the height of the pressure sensor 1 to be suppressed, whereby the size of the pressure sensor 1 (height thereof) can be reduced. In the present embodiment, the pressure sensor device 3 is connected to the flexible wiring substrate 23 via the bonding wires BY2 and electrically connected to the IC chip 4 via the wiring lines 232.

Further, in the present embodiment, the package 2 has a protrusion 25, which protrudes inward in the cavity 24. Providing the protrusion 25 allows the volume of the cavity 24 to be reduced, whereby the amount of filler 5 with which the cavity 24 is filled can be reduced. As a result, the cavity 24 can be filled with the filler 5 in a shorter period, and the material cost of the filler 5 can be lowered.

Further, the protrusion 25 is so arranged as to overlap with the IC chip 4 but as not to overlap with the pressure sensor device 3 in the plan view viewed in the normal direction Z. The arrangement allows the flexibility of the arrangement of the pressure sensor device 3 in the cavity 24 (flexibility in upward/downward direction, in particular), whereby the middle points O1 and O2 of the filler 5 and the pressure sensor device 3 can be readily positioned.

The thus configured second embodiment can also provide the same advantageous effect as that provided by the first embodiment described above.

### Third Embodiment

An altimeter according to a third embodiment of the invention will next be described.

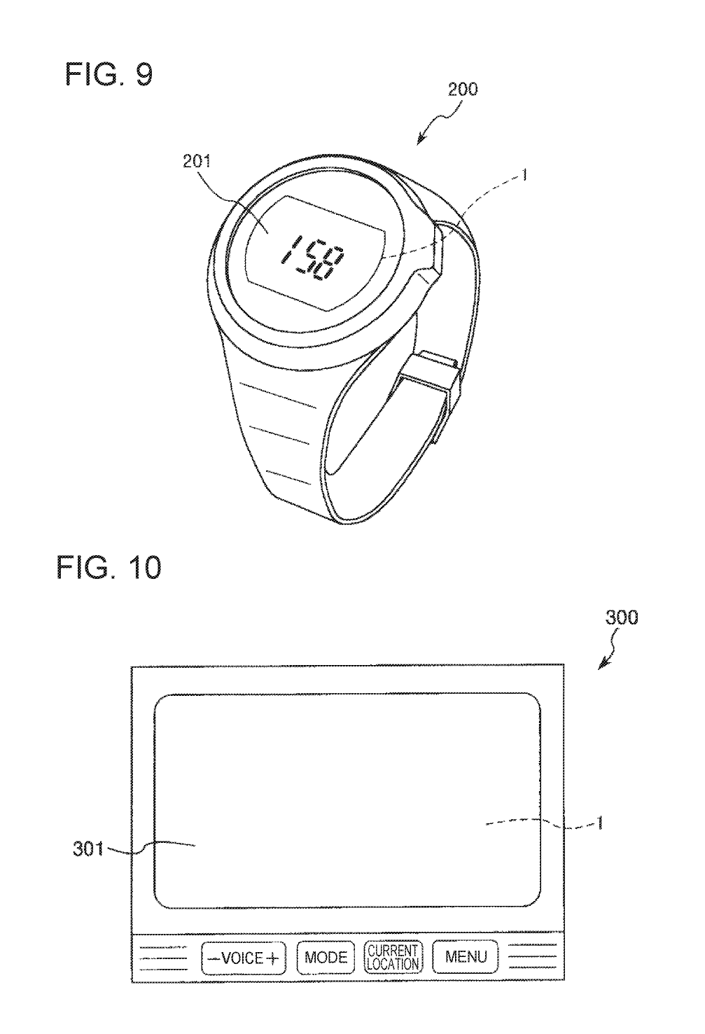

FIG. 9 is a perspective view showing an example of the altimeter according to the embodiment of the invention.

An altimeter 200 shown in FIG. 9 can be worn around a wrist as if it were a wristwatch. The pressure sensor 1 is incorporated in the altimeter 200, and the altitude of the current location above sea level, the atmospheric pressure at the current location, or any other information can be displayed in a display section 201. The display section 201 can display a variety of pieces of information, such as the current time, a user's heart rate, and the weather, as well as the altitude and atmospheric pressure. The thus configured altimeter 200, which includes the pressure sensor 1, can be highly reliable.

### Fourth Embodiment

An electronic apparatus according to a fourth embodiment of the invention will next be described.

FIG. 10 is a front view showing an example of the electronic apparatus according to the fourth embodiment of the invention.

The electronic apparatus according to the present embodiment is a navigation system 300 including the pressure sensor 1. The navigation system 300 includes map information that is not shown, a position information acquisition section that acquires position information from a GPS (global positioning system), a self-contained navigation section based on a gyro sensor and an acceleration sensor as well as vehicle speed data, the pressure sensor 1, and a display section 301, which displays predetermined position information or route information, as shown in FIG. 10.

According to the navigation system 300, altitude information can be acquired in addition to the acquired position information. For example, in a case where a vehicle with no altitude information (pressure sensor 1) travels along an elevated road so expressed in positional information as to have roughly the same position as the position representing a ground road, a navigation system of related art cannot determine whether the vehicle travels along the ground road or the elevated road and undesirably provides a user with information on the ground road as priority information in some cases.

Incorporating the pressure sensor 1 in the navigation system 300 and causing the pressure sensor 1 to acquire altitude information allows detection of a change in altitude that occurs when the vehicle travels out of the ground road onto the elevated road, whereby the user can be provided with navigation information on a running state along the elevated road.

The electronic apparatus according to the embodiment of the invention is not limited to the navigation system 300 described above and can, for example, be a smartphone, a tablet terminal, a timepiece, a personal computer, a mobile phone, a medical apparatus (electronic thermometer, blood pressure gauge, blood sugar meter, electrocardiograph, ultrasonic diagnostic apparatus, and electronic endoscope, for example), a variety of measuring apparatus, a variety of instruments (such as instruments in vehicles, airplanes, and ships), and a flight simulator.

### Fifth Embodiment

A moving object according to a fifth embodiment of the invention will next be described.

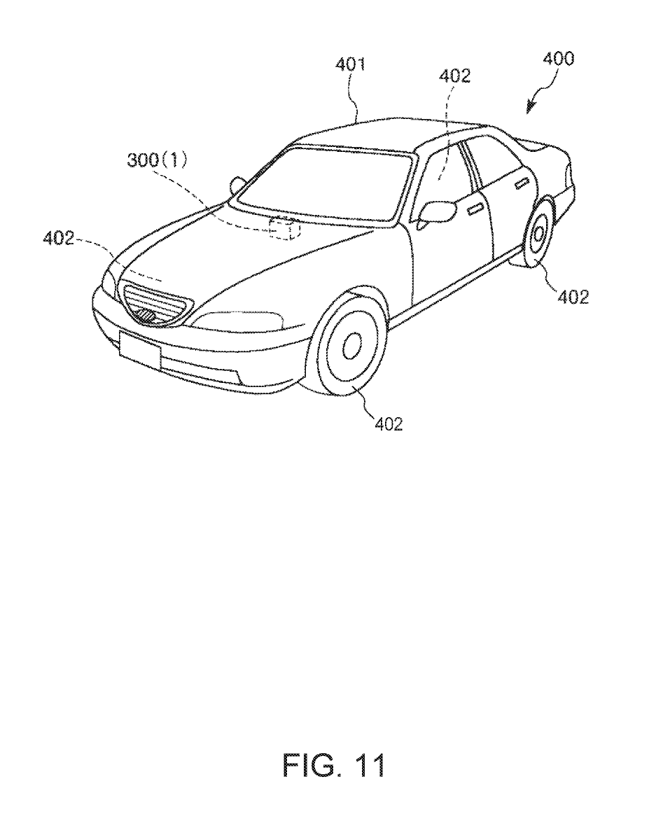

FIG. 11 is a perspective view showing an example of the moving object according to the fifth embodiment of the invention.

The moving object according to the present embodiment is an automobile 400 including the pressure sensor 1. As shown FIG. 11, the automobile 400 includes a vehicle body 401 and four wheels 402, and a power source (engine) that is not shown but is provided in the vehicle body 401 rotates the wheels 402. The thus configured automobile 400 accommodates the navigation system 300 (pressure sensor 1).

The pressure sensor, the altimeter, the electronic apparatus, and the moving object according to the embodiments of the invention have been described above with reference to the drawings, but the invention is not limited thereto. The configuration of each portion in the embodiments can be replaced with an arbitrary configuration having the same function, and another arbitrary configuration and step may be added. Further, the embodiments may be combined with each other as appropriate.

In the embodiments described above, the description has been made with reference to the case where piezo-resistance sections are used as the pressure sensor section. The pressure sensor section is, however, not necessarily configured as described above and can, for example, have a configuration in which a flap-type vibrator is used or can, for example, use a MEMS vibrator, such as an comb-tooth electrode, and a vibration device, such as a quartz crystal vibrator.

The entire disclosure of Japanese Patent Application No. 2015-189318, filed Sep. 28, 2015 is expressly incorporated by reference herein.

What is claimed is:

1. A pressure sensor comprising:
a package having a cavity;
a pressure sensor device arranged in the cavity; and
a filler that is arranged in the cavity and covers the pressure sensor device,
wherein the pressure sensor device has a diaphragm having a pressure receiving surface and a pressure reference chamber arranged on a side opposite the pressure receiving surface with respect to the diaphragm, and
in a direction of a normal to the pressure receiving surface,
between a first imaginary plane containing an end surface that is a surface of the pressure sensor device and faces the pressure receiving surface and a second imaginary plane containing an end surface that is another surface of the pressure sensor device and faces the pressure reference chamber is located a middle point between opposite ends of the filler in the normal direction.

2. The pressure sensor according to claim 1, wherein the middle point between the opposite ends of the filler in the normal direction is located between a third imaginary plane containing the pressure receiving surface and the second imaginary plane.

3. The pressure sensor according to claim 2, wherein the middle point between the opposite ends of the filler in the normal direction is located between the third imaginary plane and a fourth imaginary plane containing a surface of the diaphragm on a side opposite the pressure receiving surface.

4. The pressure sensor according to claim 1, wherein in a plan view viewed in the normal direction, a middle point of the filler in an in-plane direction of the pressure receiving surface is located in an area that overlaps with the pressure sensor.

5. The pressure sensor according to claim 4, wherein in the plan view viewed in the normal direction, the middle point of the filler in the in-plane direction is located in an area that overlaps with the pressure receiving surface.

6. The pressure sensor according to claim 1, further comprising a circuit substrate arranged in the cavity.

7. The pressure sensor according to claim 6, wherein in the direction of a normal to the pressure receiving surface, the pressure sensor device and the circuit substrate are so arranged as to be aligned with each other.

8. The pressure sensor according to claim 6, wherein in an in-plane direction of the pressure receiving surface, the pressure sensor device and the circuit substrate are so arranged as to be aligned with each other.

9. The pressure sensor according to claim 1, wherein the package has a protrusion that protrudes inward in the cavity.

10. An altimeter comprising the pressure sensor according to claim 1.

11. An altimeter comprising the pressure sensor according to claim 2.

12. An altimeter comprising the pressure sensor according to claim 3.

13. An altimeter comprising the pressure sensor according to claim 4.

14. An electronic apparatus comprising the pressure sensor according to claim 1.

15. An electronic apparatus comprising the pressure sensor according to claim 2.

16. An electronic apparatus comprising the pressure sensor according to claim 3.

17. An electronic apparatus comprising the pressure sensor according to claim 4.

18. A moving object comprising the pressure sensor according to claim 1.

19. A moving object comprising the pressure sensor according to claim 2.

20. A moving object comprising the pressure sensor according to claim 3.
